(19) United States
(12) Patent Application Publication
(10) Pub. No.: US 2025/0260168 A1
(43) Pub. Date: Aug. 14, 2025

(54) ADDITIVELY MANUFACTURED ELECTROMAGNETICALLY COUPLED PATCH ANTENNA

(71) Applicant: BAE SYSTEMS Information and Electronic Systems Integration Inc., Nashua, NH (US)

(72) Inventors: Jean L. Kubwimana, Merrimack, NH (US); Arturs E. Dinbergs, Hollis, NH (US); Alexander D. Johnson, Waltham, MA (US); Jacob Tamasy, Nashua, NH (US)

(73) Assignee: BAE SYSTEMS Information and Electronic Systems Integration Inc., Nashua, NH (US)

(21) Appl. No.: 18/438,921

(22) Filed: Feb. 12, 2024

(51) Int. Cl. H01Q 9/04; B33Y 80/00

(52) U.S. Cl. CPC H01Q 9/0421; B33Y 80/00; H01Q 9/045

(57) ABSTRACT

An antenna assembly includes a conductive ground plane, a lower layer of dielectric material above the ground plane, and an upper layer of dielectric material above the lower layer of dielectric material. In an example, at least one of the lower or upper layers of dielectric material comprise dielectric foam. The antenna assembly further includes a conductive feed line between at least a section of the lower layer of dielectric material and the upper layer of dielectric material, and a conductive patch above the upper layer of dielectric material. In an example, a dielectric constant of the lower layer of dielectric material is at least 25%, or at least 50% more, or at least 100% more, or at least 200% more, or at least 500% more than a dielectric constant of the upper layer of dielectric material.

### FIELD OF DISCLOSURE

The present disclosure relates to antennas, and more particularly, to electromagnetically coupled (EMC) patch antenna structures.

### BACKGROUND

A patch antenna is a type of low profile antenna that can be mounted on a surface. It includes a sheet or “patch” of metal above a substrate that is deposited over a larger ground plane metal sheet. The metal patch provides a resonant transmission line, with its length corresponding to approximately one-half the wavelength of the resonant frequency. A patch antenna is often used at the radio frequency (RF) range, as such wavelengths are relatively short, which in turn allows the patches to be relatively small. There remain a number of non-trivial challenges with respect to designing and manufacturing patch antenna structures.

### BRIEF DESCRIPTION OF THE DRAWINGS

FIGS. 1A, 1B, and 1C illustrate various views of an electromagnetically coupled (EMC) patch antenna structure that includes a ground plane, one or more lower layers of dielectric material above the ground plane, one or more feed lines within the one or more lower layers of dielectric material, an upper layer of dielectric material above the one or more lower layers of dielectric material, and a radiating conductive patch above the upper layer of dielectric material, in accordance with an embodiment of the present disclosure.

FIG. 2A illustrates a cross-sectional view of an EMC patch antenna structure having a single lower layer of dielectric material above a ground plane, one or more feed lines within the lower layer of dielectric material, an upper layer of dielectric material above the lower layer of dielectric material, and a radiating conductive patch above the upper layer of dielectric material, in accordance with an embodiment of the present disclosure.

FIG. 2B illustrates a cross-sectional view of an EMC patch antenna structure having a lower layer of dielectric material above a ground plane, one or more feed lines above the lower layer of dielectric material, an upper layer of dielectric material above the lower layer of dielectric material, and a radiating conductive patch above the upper layer of dielectric material, in accordance with an embodiment of the present disclosure.

FIG. 2C illustrates a cross-sectional view of an EMC patch antenna structure having a lower layer of dielectric material above a ground plane, one or more feed lines within the lower layer of dielectric material, an upper layer of dielectric material above the lower layer of dielectric material, a radiating conductive patch above the upper layer of dielectric material, and a top layer of dielectric material at least in part above the radiating conductive patch, in accordance with an embodiment of the present disclosure.

FIG. 3 illustrates a cross-sectional view of an EMC patch antenna structure having a direct current (DC) shorting structure between a ground plane and a radiating conductive patch above the ground plane, in accordance with an embodiment of the present disclosure.

FIG. 4 illustrates a flowchart depicting a method of forming an antenna assembly, in accordance with an embodiment of the present disclosure.

FIGS. 5A, 5B, 5C, 5D, 5E, 5F, 5G1, and 5G2 collectively illustrate an antenna assembly in various stages of processing in accordance with the methodology of FIG. 4, in accordance with an embodiment of the present disclosure.

FIG. 6 illustrates a flowchart depicting a method of forming an antenna assembly, in accordance with another embodiment of the present disclosure.

FIGS. 7A, 7B, 7C, and 7D collectively illustrate an antenna assembly in various stages of processing in accordance with the methodology of FIG. 6, in accordance with an embodiment of the present disclosure.

Although the following detailed description will proceed with reference being made to illustrative examples, many alternatives, modifications, and variations thereof will be apparent in light of this disclosure.

### DETAILED DESCRIPTION

Electromagnetically coupled (EMC) patch antenna assemblies are disclosed. An EMC patch antenna is configured for or otherwise capable of electromagnetic coupling between one or more feed line(s) and a patch that is radiating. In one embodiment, an antenna assembly includes a conductive ground plane, a lower layer of dielectric material above the ground plane, and an upper layer of dielectric material above the lower layer of dielectric material. In an example, at least one of the lower or upper layers of dielectric material comprise dielectric foam. The antenna assembly further includes a conductive feed line between at least a section of the lower layer of dielectric material and the upper layer of dielectric material, and a conductive patch above the upper layer of dielectric material. Because the patch can be electromagnetically excited via the feed line, there is no need for solder joints or other such physical connections attendant a probe-fed patch. Although such EMC patch antennas can be used for many applications, these EMC patch antennas may be particularly well-suited for applications in which the antenna structure may endure vibrations, such as in Global Positioning System (GPS) that is affixed or otherwise included in a vehicle or an airborne platform, or any other platform susceptible to vibration conditions that are problematic for solder-based feed connections.

Furthermore, one or more layers of dielectric material of the patch antenna may be manufactured using additive manufacturing processes, such as three-dimensional (3D) printing or a foaming process. Because of the nature of the additive manufacturing process, a height of such layer(s) of dielectric material may be fine-tuned, which in turn allows fine tuning of one or more antenna parameters (such as bandwidth, antenna gain, phase, and/or one or more other antenna parameters) of the patch antenna assembly. Also, the dielectric constants of the lower layer of dielectric and the upper layer of dielectric material can vary, from one example to the next. In some examples, a dielectric constant of the lower layer of dielectric material is at least 25%, or at least 50% more, or at least 100% more, or at least 200% more, or at least 500% more than a dielectric constant of the upper layer of dielectric material.

In another embodiment, a method of manufacturing an antenna assembly comprises additively forming a conductive ground plane, providing a lower layer of dielectric material above the ground plane, forming a feed line on the lower layer of dielectric material, providing an upper layer of dielectric material above the feed line, and forming a conductive patch above upper layer of dielectric material.

In yet another embodiment, another method of manufacturing an antenna assembly comprises additively manufacturing an element that includes (i) a ground plane, (ii) a patch above the ground plane, and (iii) a structure having a first end in contact with the ground plane and a second end in contact with the patch. In an example, additively manufacturing the element comprises printing the element using a three-dimensional (3D) printing process. The method further comprises providing a lower layer of dielectric material between the ground plane and the patch, forming a feed line on or within the lower layer of dielectric material, and providing an upper layer of dielectric material between the feed line and the patch. In an example, the upper layer of dielectric material is provided using a foaming process. In one example, the method further comprises removing at least a portion of the structure, such that a remnant of the structure, if any, is no longer in contact with the ground plane and/or the patch. In another example, the structure forms a direct current (DC) shorting structure between the ground plane and the patch. Numerous configurations and variations will be apparent in light of this disclosure.

General Overview

As mentioned herein above, there remain a number of non-trivial challenges with respect to designing and manufacturing patch antenna assemblies. For example, a probe-fed patch antenna uses a probe that is physically connected (e.g., via solder or conductive epoxy) to a radiating patch of the patch antenna assembly. The probe may be, for example, an elongated center conductor of a standard coaxial connector. The ground portion of the connector is soldered or otherwise conductively bonded to a ground plane, and the end of the probe (center conductor) is soldered or otherwise conductively bonded to the patch. However, these solder joints or physical conductive bonds are vulnerable to shock and other stresses, e.g., especially in applications that may endure vibrations during use. Additionally, it may be desirable to tune parameters of a patch antenna, which may often be cumbersome, e.g., due to difficulties in controlling or tuning dimensions of various components of the patch antenna.

Accordingly, techniques are described herein to form an electromagnetically coupled (EMC) patch antenna, which is configured for electromagnetic coupling between the feed line(s) and the patch. Thus, there is no solder joint between a given connector and the ground plane, and/or between the connector and the patch. Additionally, one or more layers of dielectric material of the patch antenna may be manufactured using additive manufacturing processes, such as a foaming process. Because of the nature of the additive manufacturing process, a height of such layer(s) of dielectric material may be fine-tuned, which in turn allows fine tuning of one or more antenna parameters (such as bandwidth, resonant frequency, antenna gain, phase, and/or other antenna parameters) of the patch antenna assembly. For instance, changing the height of the one or more layers of dielectric material affects the effective electrical length of the patch, which, in turn, affects the resonant frequency. In an example, increasing the height may lower the resonant frequency, while decreasing the height may increase the resonant frequency. Similarly, a thicker layer of dielectric material may provide a wider bandwidth, allowing the antenna to operate over a broader range of frequencies. This is because the thicker layer supports more modes of propagation. Thus, having control of the height of the one or more layers of dielectric material via additive manufacturing allows for tuning the antenna to a desired effective electrical length and resonance, while reasonably maintaining the radiation performance, such as gain and bandwidth. In one embodiment for the additively manufacturing the one or more layers of dielectric material, modeling and simulation tools are employed to determine the appropriate dielectric layer heights for the desired frequency response and properties such as the bandwidth, resonant frequency, gain, and phase. Once the modeling is completed, the one or more layers of dielectric material are additively manufactured in accordance with the specification.

In one embodiment, the antenna assembly comprises a conductive ground plane, which comprises at least partially electrically conductive material (e.g., comprises one or more metals and/or alloys thereof). In another example, the ground plane is at least partially non-conductive and at least partially plated with conductive material (e.g., a metal plating).

The antenna assembly further comprises one or more lower layers of dielectric material above the ground plane, and an upper layer of dielectric material above the one or more lower layers of dielectric material. For example, the lower layers of dielectric material comprise a first lower layer of dielectric material above the ground plane, and a second lower layer of dielectric material above the first lower layer of dielectric material. Any appropriate type of dielectric material may be used for the lower layers, such as foam, glass and/or ceramic material, composite laminate, epoxy, resin, and/or another appropriate dielectric or composite material (e.g., a composite material comprising woven fiberglass cloth and an epoxy resin binder, such as FR-4). In an example, the lower layers comprise dielectric foam material.

In an example, the lower layers of dielectric material may be additively manufactured above the ground plane, such as formed using a foaming process or another appropriate additive manufacturing process, as will be described below. Accordingly, in an example, a height of each of the lower layers of dielectric material may be controlled or fine-tuned, which allows to fine-tune associated antenna characteristics.

In one embodiment, one or more conductive feed lines are between the first and second lower layers of dielectric material. Thus, in an example, the conductive feed lines are within the lower layers of dielectric material. In an example, the antenna assembly includes two feed lines, e.g., to form a dual polarized antenna structure. However, in another example, a single feed line may be used instead, e.g., to form a single polarized antenna structure. In any case, current or other stimulus can be applied to the corresponding feed lines. In some cases the feed lines are driven by on-board circuitry (e.g., RF receiver circuitry). In other examples, the feed lines may be coupled to cabling or other conductive runs and circuitry that deliver the signals to excite the patch antenna.

In one embodiment, an upper layer of dielectric material is above the lower layers of the dielectric material. Any appropriate type of dielectric material may be used for the upper layer, such as an epoxy, foam, resin, and/or another appropriate dielectric composite material. In an example, the upper layer of dielectric material comprises dielectric foam material. In an example, the upper layer of dielectric material may be additively manufactured, such as formed using a foaming process. Accordingly, in an example, a height of the upper layer of dielectric material may be controlled or fine-tuned, which allows fine-tuning of associated antenna characteristics.

In an example, a dielectric constant of each of the lower layers of dielectric material is higher than a dielectric constant of the upper layer of dielectric material, e.g., by at least 1.25×, or at least 1.5×, or at least 2×, or at least 5×, or at least 10×. For example, the upper layer of dielectric material comprises a foam dielectric material, resulting in the dielectric constant of the upper layer of dielectric material being lower than the dielectric constant of the lower layers of dielectric material.

In one embodiment, the antenna assembly further comprises a conductive radiating patch above the upper layer of dielectric material. The patch comprises a conductive material (such as metal, for example, copper, and/or an alloy thereof), or a non-conductive material at least partially plated with a conductive material (e.g., a metal plating). The radiating patch is capable of being electromagnetically excited by the feed lines that are between the patch and the ground plane. Thus, the feed lines are electromagnetically coupled to the patch.

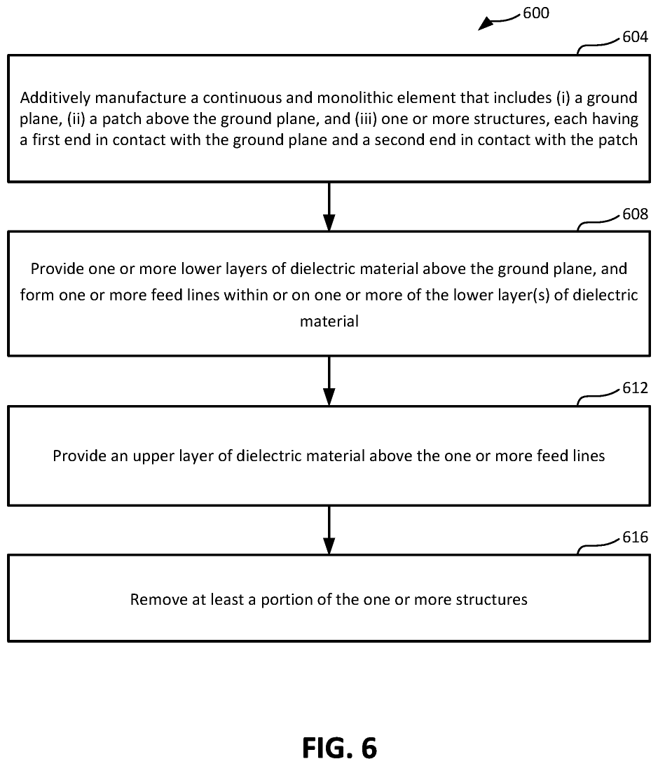

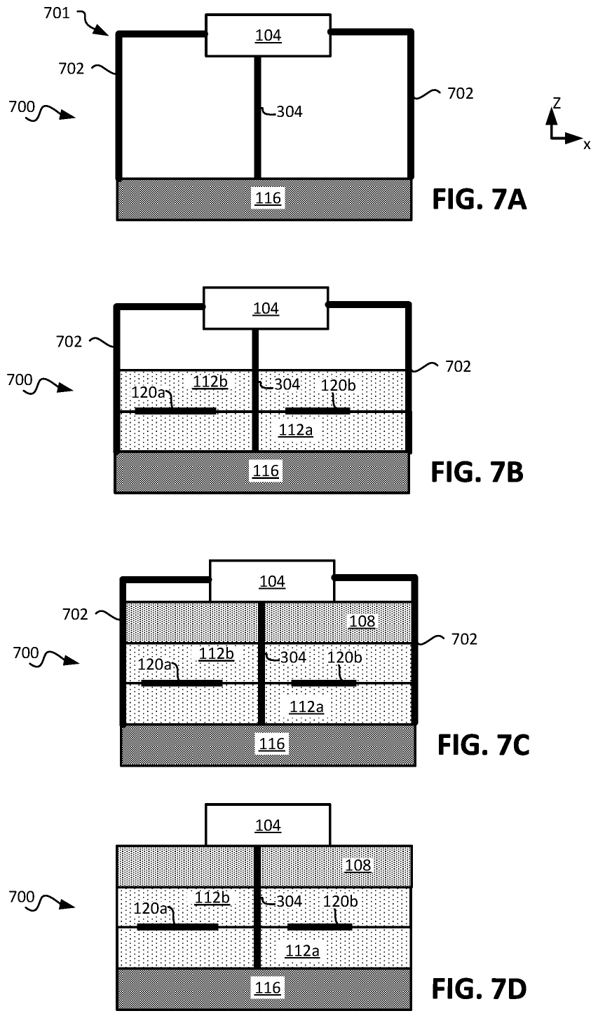

In one embodiment, the antenna assembly includes a direct current (DC) shorting structure (e.g., a shorting pin) between a ground plane and the patch above the ground plane. In an example, the shorting structure comprises conductive material, e.g., similar to the conductive material of the ground plane and/or the patch. In an example, the conductive shorting structure affects, such as improves, bandwidth of the antenna assembly. In an example and as will be described below (e.g., see FIGS. 6-7D), the patch, the shorting structure, and/or the ground plane may be manufactured using an additive manufacturing process, such as a 3D printing process. For example, the ground plane, the shorting structure, and/or the patch may be manufactured using a same material deposition process. In such an example, there may not be an interface (such as a seam) between the shorting structure and the patch, and/or between the shorting structure and the ground plane, e.g., due to formation of these components using a same deposition process.

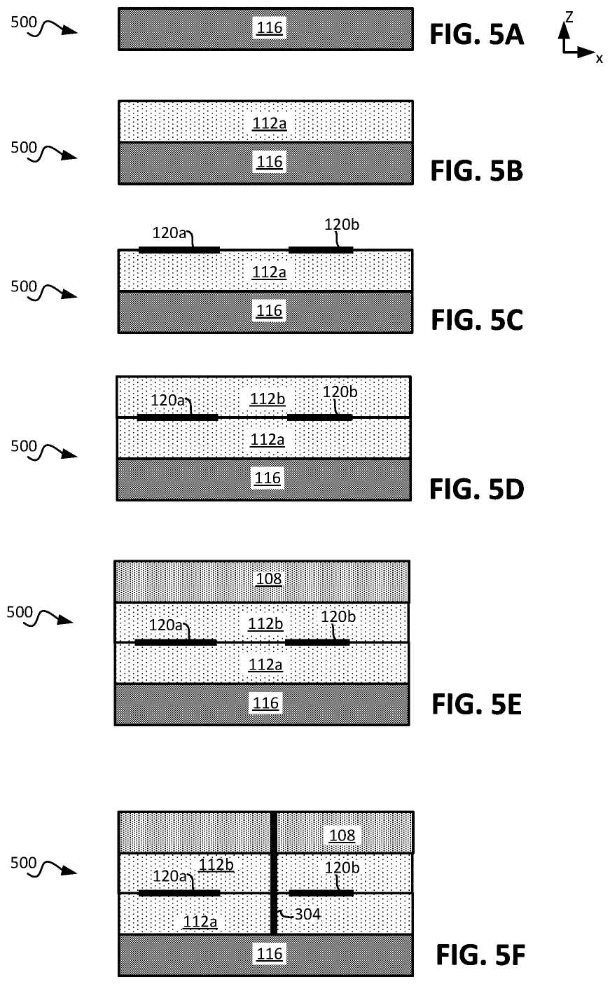

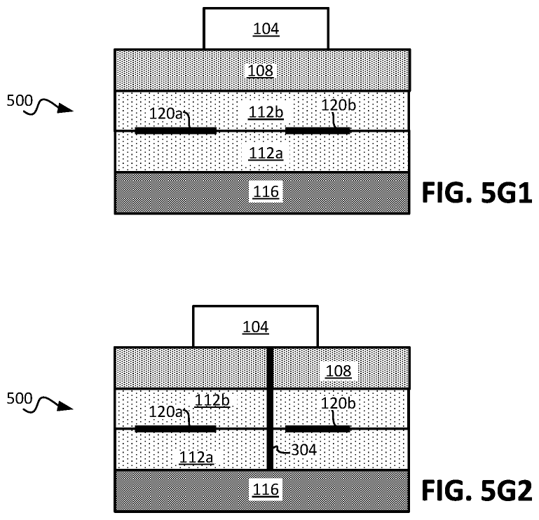

Various example techniques for forming the antenna assembly are described herein below. In one example method of forming the antenna assembly (e.g., as described with respect to FIGS. 4-5G2 below), the ground plane is formed, followed by formation of a first lower layer of dielectric material above the ground plane. The feed lines are formed above the first lower layer of dielectric material, and then the second lower layer of dielectric material is formed above the first lower layer of dielectric material and the feed lines. In an example, one or more of the first and second lower layers of dielectric material may be additively formed, e.g., using a foaming process. Subsequently the upper layer of dielectric material is formed above the lower layers of dielectric material, e.g., using a foaming process. The patch is finally formed above the upper layer of dielectric material.

In another example method of forming the antenna assembly (e.g., as described with respect to FIGS. 6-7D below), an element comprising the ground plane, the patch, one or more structures is formed using an additive manufacturing process, such as a 3D printing process. The one or more structures support the patch above the ground plane. One such example structure may be sacrificial in nature and may later be removed (such as the structure 702 of FIGS. 7A-7C). Another such example structure may form the shorting structure or shorting pin between the patch and the ground plane, and may not be removed later (such as the shorting structure 304 of FIGS. 7A-7D). In an example, the element is a continuous, monolithic, and conductive element. The element being a monolithic and continuous element implies that any section of the element is conjoined (e.g., physically joined) with any other section of the element via one or more intervening sections. Thus, the element is a single integral conductive element that has been additively manufactured.

In an example, additively manufacturing the element may include using any appropriate additive manufacturing techniques to form the element. For example, additively manufacturing the element may include printing the element using a 3D printer. Additive manufacturing, such as 3D printing, uses computer-aided-design (CAD) software and/or 3D object scanners to direct hardware to deposit material, layer upon layer, in precise geometric shapes. As its name implies, additive manufacturing adds material to create an object. Thus, additive manufacturing involves a computer controlled process that creates 3D objects, such as the element, by depositing materials, usually in layers.

Subsequent to forming the monolithic element, one or more lower layers of dielectric material are provided above the ground plane (e.g., using an additive manufacturing technique or another appropriate technique), and one or more feed lines are formed within or on the lower layer(s) of dielectric material, as also described above. Subsequently, an upper layer of dielectric material above the one or more feed lines is provided (e.g., see FIG. 7C), such as using a foaming process.

Note that the upper layer of dielectric material now can support the patch above the ground plane. Accordingly, the structures of the monolithic element, which were previously used to support the patch above the ground plane, may optionally be removed (e.g., unless the structures are used as shorting structures in the antenna assembly), e.g., using an appropriate machining or drilling technique. Numerous configurations and variations will be apparent in light of this disclosure.

Materials that are “compositionally different” or “compositionally distinct” as used herein refers to two materials that have different chemical compositions. This compositional difference may be, for instance, by virtue of an element that is in one material but not the other (e.g., copper is compositionally different than an alloy of copper), or by way of one material having all the same elements as a second material but at least one of those elements is intentionally provided at a different concentration in one material relative to the other material (e.g., two copper alloys each having copper and tin, but with different percentages of copper, are also compositionally different). If two materials are elementally different, then one of the materials has an element that is not in the other material (e.g., pure copper is elementally different than an alloy of copper).

It should be readily understood that the meaning of “above” and “over” in the present disclosure should be interpreted in the broadest manner such that “above” and “over” not only mean “directly on” something but also include the meaning of over something with an intermediate feature or a layer therebetween. As will be appreciated, the use of terms like “above” “below” “beneath” “upper” “lower” “top” and “bottom” are used to facilitate discussion and are not intended to implicate a rigid structure or fixed orientation; rather such terms merely indicate spatial relationships when the structure is in a given orientation.

### Architecture

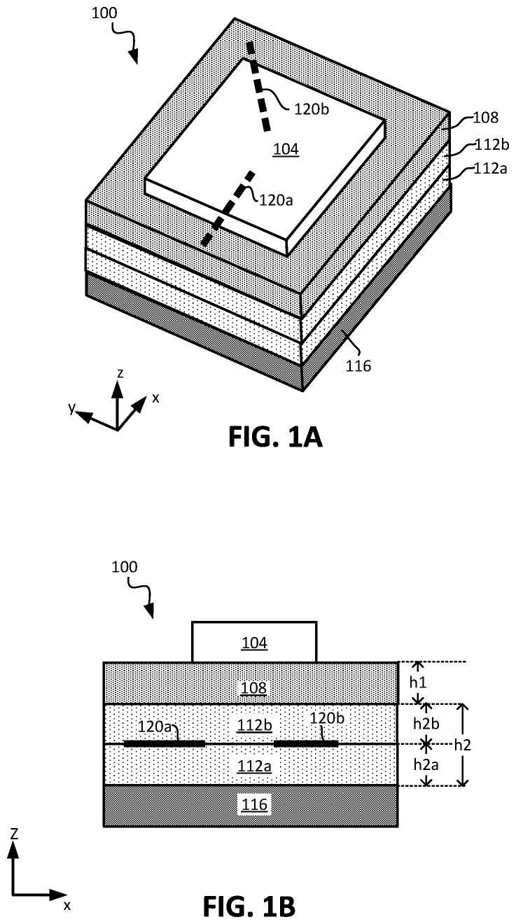

FIG. 1A illustrates a perspective view, FIG. 1B illustrates a cross-sectional view, and FIG. 1C illustrates an exploded view of an electromagnetically coupled (EMC) patch antenna structure 100 (also referred to herein as an antenna structure 100, or simply as a structure 100), wherein the patch antenna structure 100 comprises a ground plane 116, one or more lower layers 112a, 112b of dielectric material above the ground plane 116, one or more feed lines 120a, 120b within the one or more lower layers 112a, 112b of dielectric material, an upper layer 108 of dielectric material above the one or more lower layers 112a, 112b of dielectric material, and a radiating conductive patch 104 above the upper layer 108 of dielectric material, in accordance with an embodiment of the present disclosure. As will be described below, the structure 100 (e.g., at least some of the components of the structure 100) may be additively manufactured, and hence, the structure 100 is also referred to as an additively manufactured electromagnetically coupled patch antenna structure 100.

Referring to FIGS. 1A-1C, the structure 100 comprises a conductive ground plane 116. For example, the ground plane 116 comprises material is at least partially electrically conductive (e.g., comprises one or more metals and/or alloys thereof). In another example, the material of the ground plane 116 is at least partially non-conductive and at least partially plated with another conductive material (e.g., a metal plating). In an example, the ground plane 116 comprises an appropriate metal such as copper, and/or an alloy thereof.

The structure 100 comprises one or more lower layers 112a, 112b of dielectric material above the ground plane 116, and an upper layer 108 of dielectric material above the one or more lower layers 112a, 112b of dielectric material. For example, the lower layers of dielectric material comprise two such lower layers 112a, 112b of dielectric material. In such an example, the lower layers 112a, 112b of dielectric material may be compositionally and/or elementally the same, although they may be different in another example.

Any appropriate type of dielectric material may be used for the lower layers 112a, 112b, such as an appropriate dielectric material used in printed circuit boards (PCBs), a composite material comprising woven fiberglass cloth and an epoxy resin binder, glass and/or ceramic material, composite laminate, foam, epoxy, resin, and/or another appropriate dielectric material. In an example, the lower layers 112a, 112b comprise dielectric foam material.

In one embodiment, one or more conductive feed lines 120a, 120b are between the lower layer 112a and the lower layer 112b. Thus, in an example, the conductive feed lines 120a, 120b are embedded within the lower layers 112a, 112b.

In the perspective view of FIG. 1A, the feed lines 120a, 120b would not be visible (e.g., as being covered by the layers 108 and 112b), and hence, are illustrated in dotted lines in this figure. The feed lines 120a, 120b are visible in FIGS. 1B and 1C.

The feed lines 120a, 120b comprise conductive material, such as one or more metals and/or alloys thereof. The two feed lines 120a, 120b are used to form a dual polarized antenna structure 100. However, a single feed line may be used instead, e.g., to form a single polarized antenna structure.

As illustrated in FIG. 1B, at least a section of the feed line 120a may be below (e.g., vertically below) the patch 104, and similarly, at least a section of the feed line 120b may be below (e.g., vertically below) the patch 104. For example, a vertical imaginary line, which is orthogonal to a plane of the patch 104 and the ground plane 116, passes through the patch 104 and the feed line 120a. Similarly, another vertical imaginary line, which is orthogonal to a plane of the patch 104 and the ground plane 116, passes through the patch 104 and the feed line 120b. However, in another example, no section of the feed lines 120a and/or 120b may be below (e.g., vertically below) the patch 104.

Although not illustrated, an end of the feed line 120a (such as a left end of the feed line 120a in the orientation of FIG. 1B) may be in electrical connection with a cable connector, which supplies current to the feed line 120a. Similarly, although not illustrated, an end of the feed line 120b (such as a right end of the feed line 120b in the orientation of FIG. 1B) may be in electrical connection with another cable connector, which supplies current to the feed line 120b.

In an example, the lower layers 112a, 112b of dielectric material may be additively manufactured above the ground plane 116, such as formed using a foaming process or another appropriate additive manufacturing process, as will be described below. In an example, additively manufacturing the lower layers 112a, 112b facilitates in controlling or fine tuning vertical Z-axis heights of the lower layers 112a, 112b. For example, as illustrated in FIG. 1B, the vertical Z-axis heights of the lower layers 112a, 112b are h2a and h2b, respectively, such that a combined vertical Z-axis height of the lower layers 112a, 112b is h2. The heights h2a, h2b, and/or h2 may be used to tune one or more antenna characteristics (such as bandwidth, antenna gain, phase, and/or one or more other antenna characteristics). Additively manufacturing the lower layers 112a, 112b facilitates in fine tuning the heights h2a, h2b, and/or h2, thereby facilitates controlling associated antenna characteristics.

The upper layer 108 of dielectric material is above the lower layer 112b of the dielectric material. Any appropriate type of dielectric material may be used for the upper layer 108, such as an epoxy, foam, resin, and/or another appropriate dielectric composite material. In an example, the upper layer 108 comprise dielectric foam material. In an example, the upper layer 108 of dielectric material may be additively manufactured, such as formed using a foaming process above the lower layers 112a, 112b. In an example, additively manufacturing the upper layer 108 facilitates in controlling or fine tuning vertical Z-axis height of the upper layer 108. For example, as illustrated in FIG. 1B, the vertical Z-axis height of the upper layer 108 is h1. The height h1 (e.g., along with the heights h2a, h2b, and/or h2) may be used to tune antenna characteristics (such as bandwidth, antenna gain, phase, and/or one or more other antenna characteristics). Additively manufacturing the upper layer 108 facilitates in fine tuning the height h1, thereby facilitates in controlling associated antenna characteristics. In some examples, heights h2a, h2b, h1 of one or more of the layers 112a, 112b, 108 of dielectric material may influence the bandwidth of the patch antenna structure 100 and/or the resonant frequency of the antenna. For instance, changing the heights h2a, h2b, h1 of the one or more layers of dielectric material affects the effective electrical length of the patch 104, which, in turn, affects the resonant frequency of the patch antenna structure 100. The heights h2a, h2b, h1 of the one or more layers 112a, 112b, 108 of dielectric material may also influence the bandwidth of the patch antenna structure 100. In an example, increasing one or more of the heights h2a, h2b, h1 may lower the resonant frequency, while decreasing one or more of the heights h2a, h2b, h1 may increase the resonant frequency. Similarly, a thicker layer of dielectric material supports more modes of propagation and therefore may provide a wider bandwidth, allowing the antenna to operate over a broader range of frequencies. Thus, having control of the height of the one or more layers 112a, 112b, 108 of dielectric material via additive manufacturing allows for tuning the patch antenna structure 100 to a desired resonance, while reasonably maintaining the radiation performance, such as gain and bandwidth. In one embodiment for the additively manufacturing the one or more layers 112a, 112b, and/or 108 of dielectric material, modeling and simulation tools are employed to determine the appropriate heights of the layers 112a, 112b, and/or 108 for the desired frequency response and properties such as the bandwidth, resonant frequency, gain, and phase. Once the modeling is completed, the one or more layers of dielectric material are additively manufactured in accordance with the specification.

In an example, a dielectric constant of the lower layers 112a and/or 112b of dielectric material is higher than a dielectric constant of the upper layer 108 of dielectric material, e.g., by at least 1.25×, or at least 1.5×, or at least 2×, or at least 5×, or at least 10×, where the suffix “x” denotes multiplication (e.g., 1.25× implies that the dielectric constant of a lower layer of dielectric material is higher than the dielectric constant of the upper layer of dielectric material by 1.25 times or 25%). For example, the upper layer 108 of dielectric material comprises a foam dielectric material, resulting in the dielectric constant of the upper layer 108 of dielectric material being lower than the dielectric constant of the lower layers 112a and/or 112b of dielectric material.

The structure 100 comprises a conductive radiating patch 104 above the upper layer 108 of dielectric material. The patch 104 comprises a conductive material (such as metal, for example, copper, and/or an alloy thereof), or a non-conductive material least partially plated with a conductive material (e.g., a metal plating). The radiating patch 104 is excited by the feed lines 120a, 120b that are between the patch 104 and the ground plane 116. The feed lines 120a, 120b are electromagnetically coupled to the radiating patch 104. As used herein, a radiating patch refers to a patch that is capable of radiating and not necessarily a patch that is actively radiating (e.g., a radiating patch may not be radiating when not in use). Likewise, an electromagnetically coupled (EMC) patch antenna structure as used herein refers to a patch antenna structure that is capable of electromagnetic coupling and not necessarily a patch antenna structure that is actively electromagnetically coupled (e.g., an EMC patch antenna may not be electromagnetically coupled when not in use). Given the electromagnetic coupling, there is no need for any solder joints between feed lines 120a, 120b and patch 104. Such a solder-free coupling at the feed line/patch interface is advantageous, as described above.

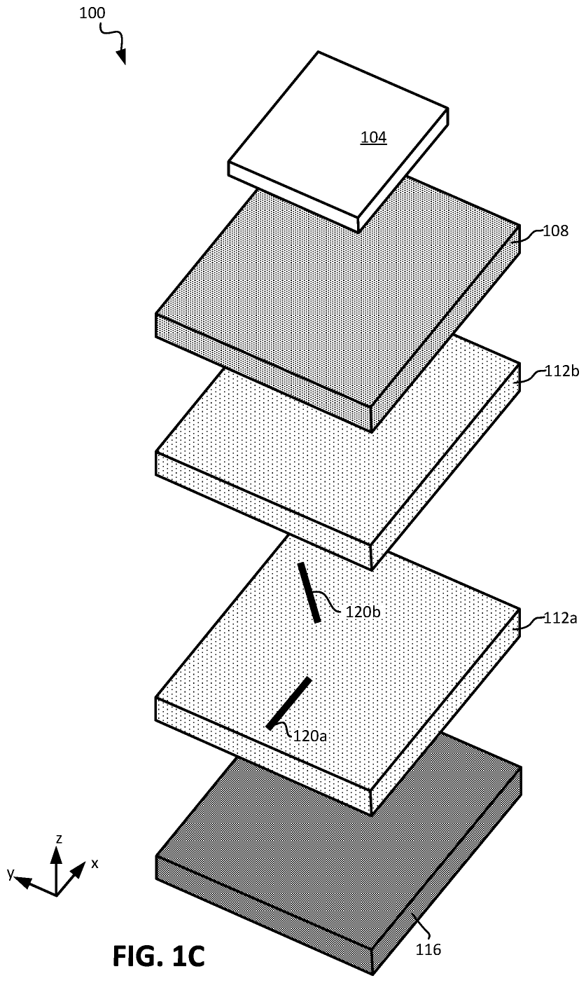

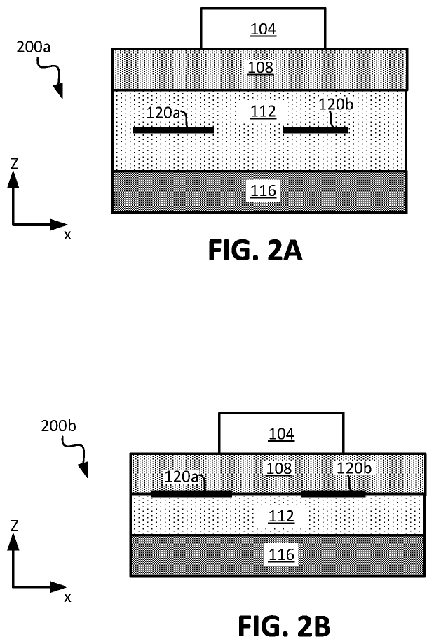

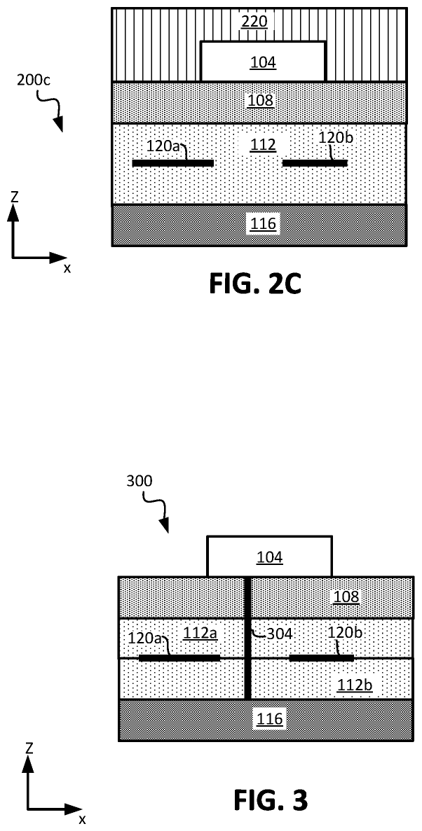

In FIGS. 1A-1C, the two lower layers 112a, 112b of dielectric material are distinct, e.g., manufactured at different times in the process flow, and/or are compositionally or elementally different. However, in another example, the two lower layers 112a, 112b of dielectric material may be replaced by a single lower layer 112 of dielectric material, which embeds the feed lines 120a, 120b, as illustrated in FIG. 2A. For example, FIG. 2A illustrates a cross-sectional view of an EMC patch antenna structure 200a (also referred to herein as an antenna structure 200a, or simply as a structure 200a) having a single lower layer 112 of dielectric material above a ground plane 116, one or more feed lines 120a, 120b within the lower layer 112 of dielectric material, an upper layer 108 of dielectric material above the lower layer 112 of dielectric material, and a radiating conductive patch 104 above the upper layer 108 of dielectric material, in accordance with an embodiment of the present disclosure. Like elements in FIGS. 1A-1C and 2A are labelled using the same labels. The antenna structure 200a of FIG. 2A will be apparent, based on the above description of the antenna structure 100 of FIG. 1A-1C.

In FIGS. 1A-1C, the feed lines 120a, 120b are embedded within the two lower layers 112a, 112b of dielectric material. However, in another example, the feed lines 120a, 120b may be above the lower layers 112a, 112b of dielectric material. For example, FIG. 2B illustrates a cross-sectional view of an EMC patch antenna structure 200b (also referred to herein as an antenna structure 200b, or simply as a structure 200b) having a lower layer 112 of dielectric material above a ground plane 116, one or more feed lines 120a, 120b above the lower layer 112 of dielectric material, an upper layer 108 of dielectric material above the lower layer 112 of dielectric material, and a radiating conductive patch 104 above the upper layer 108 of dielectric material, in accordance with an embodiment of the present disclosure. Like elements in FIGS. 1A-1C and 2B are labelled using the same labels. The antenna structure 200b of FIG. 2B will be apparent, based on the above description of the antenna structure 100 of FIG. 1A-1C.

FIG. 2C illustrates a cross-sectional view of an EMC patch antenna structure 200c (also referred to herein as an antenna structure 200c, or simply as a structure 200c) having a lower layer 112 of dielectric material above a ground plane 116, one or more feed lines 120a, 120b within the lower layer 112 of dielectric material, an upper layer 108 of dielectric material above the lower layer 112 of dielectric material, a radiating conductive patch 104 above the upper layer 108 of dielectric material, and a top layer 220 of dielectric material at least in part above the radiating conductive patch 104, in accordance with an embodiment of the present disclosure. Thus, the layer 220 of dielectric material acts as a superstrate dielectric material that is around and/or above the patch 104, in an example. Like elements in FIGS. 1A-1C and 2C are labelled using the same labels.

The antenna structure 200c of FIG. 2C will be apparent, based on the above description of the antenna structure 100 of FIG. 1A-1C.

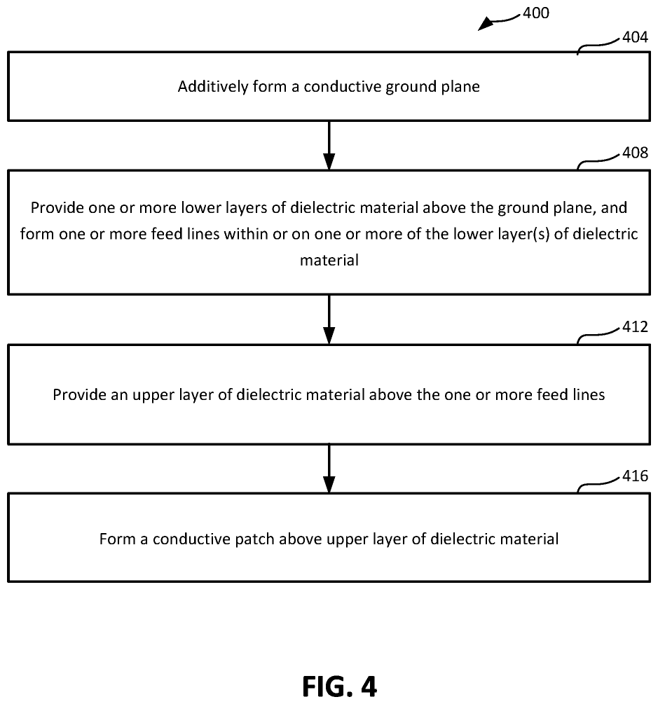

FIG. 3 illustrates a cross-sectional view of an EMC patch antenna structure 300 (also referred to herein as an antenna structure 300, or simply as a structure 300) having a direct current (DC) shorting structure 304 between a ground plane 116 and a radiating conductive patch 104 above the ground plane 116, in accordance with an embodiment of the present disclosure. Like elements in FIGS. 1A-1C and 3 are labelled using the same labels.

In an example, the shorting structure 304 comprises conductive material, e.g., similar to the conductive material of the ground plane 116 and/or the patch 104. In an example, the conductive shorting structure 304 affects, such as improves, bandwidth of the antenna structure 300.

In an example and as will be described below (e.g., see FIGS. 6-7D), the patch 104, the shorting structure 304, and/or the ground plane 116 may be manufactured using an additive manufacturing process, such as a 3D printing process. For example, the ground plane 116, the shorting structure 304, and/or the patch 104 may be manufactured using a same material deposition process. In an example, the ground plane 112, the shorting structure 426, and the patch 104 may comprise elementally and/or compositionally the same material. In such an example, there may not be an interface (such as a seam) between the shorting structure 304 and the patch 104, and/or between the shorting structure 304 and the ground plane 116, e.g., due to formation of these components using a same deposition process. For example, the ground plane 116, the shorting structure 304, and the patch 104 may comprise a continuous and monolithic body of conductive material, such as a metal and/or an alloy thereof. The antenna structure 300 of FIG. 3 will be apparent, based on the above description of the antenna structure 100 of FIG. 1A-1C.

### Method of Manufacturing

FIG. 4 illustrate a flowchart depicting a method 400 of forming an example antenna assembly (such as any of the antenna structures described above), in accordance with an embodiment of the present disclosure. FIGS. 5A, 5B, 5C, 5D, 5E, 5F, 5G1, and 5G2 collectively illustrate an example antenna assembly 500 in various stages of processing in accordance with the methodology 400 of FIG. 4, in accordance with an embodiment of the present disclosure. FIGS. 4 and 5A-5G2 will be discussed in unison.

Referring to the method 400 of FIG. 4, at 404, a conductive ground plane is formed, such as formed using an additive manufacturing process. FIG. 5A illustrates the ground plane 116. In an example, an appropriate additive manufacturing process, such as a 3D printing process, may be employed. The ground plane 116 comprises material that is at least partially electrically conductive (e.g., comprises one or more metals and/or alloys thereof). In another example, the material of the ground plane 116 is at least partially non-conductive and at least partially plated with another conductive material (e.g., a metal plating). In an example, the ground plane 116 comprises an appropriate metal such as copper, and/or an alloy thereof.

The method 400 proceeds from 404 to 408. At 408, one or more lower layers of dielectric material are provided above the ground plane, and one or more feed lines are formed within or on one or more of the lower layer(s) of dielectric material, e.g., as illustrated in FIGS. 5B, 5C, and 5D. For example, in FIG. 5B, a first lower layer 112a of dielectric material is provided above the ground plane 116. In FIG. 5C, feed lines 120a and 120b are formed on the first lower layer 112a of dielectric material. In FIG. 5D, a second lower layer 112b of dielectric material is formed on the first lower layer 112a of dielectric material and the feed lines 120a, 120b, such that the feed lines 120a, 120b are sandwiched between the first and second lower layers 112a and 112b.

In an example, the first and second lower layers 112a and 112b may be additively formed. For example, the lower layers 112a, 112b comprising dielectric foam may be provided above the ground plane 116 using any appropriate foaming technique. Merely as an example, during the foaming process, a mixture of an activator and a foaming portion may be deposited above the ground plane 116, and then the foaming mixture may be cured at an appropriate temperature, such that rigid foam forms from the activator and the foaming portion. In another example, a foaming gel or solution may be applied above the ground plane 116 and then cured, such that rigid foam forms above the ground plane 116. In yet another example, a foaming power (e.g., comprising microspheres including resins or another appropriate material) is applied and then cured at an appropriate temperature, such that the foaming power transforms to the rigid dielectric foam of the layers 112a, 112b. Any appropriate foaming process can be used, and the selection of the foaming process and/or the selection of an appropriate type of foam may be implementation specific. In an example, between the foaming processes to form the lower layers 112a and 112b, the feed lines 120a, 120b may be formed above the lower layer 112b. In an example, any appropriate deposition technique (such as a 3D printing process, or another appropriate metal deposition process) may be employed to form the feed lines 120a, 120b.

In another example, the first and second lower layers 112a and 112b may not be dielectric foam material, such as may comprise a PCB dielectric material, a laminate, an epoxy, a resin, and/or another appropriate non-foam dielectric material. In some such examples, the lower layers 112a and 112b may be pre-formed, and then attached (e.g., using adhesive) to the ground plane 116.

The method 400 proceeds from 408 to 412. At 412, an upper layer of dielectric material is provided above the one or more feed lines. For example, FIG. 5E illustrates the upper layer 108 of dielectric material above the feed lines 120a, 120b, and also above the lower layer 112b of dielectric material.

In an example, the upper layer 108 of dielectric material may be additively formed, such as using a foaming process. Examples of various foaming process have been described above.

In an example, a dielectric constant of the lower layers 112a and/or 112b of dielectric material is higher than a dielectric constant of the upper layer 108 of dielectric material, e.g., by at least 1.25×, or at least 1.5×, or at least 2×, or at least 5×, or at least 10×. For example, the upper layer 108 of dielectric material comprises a foam dielectric material having relatively lower dielectric constant, resulting in the dielectric constant of the upper layer 108 of dielectric material being lower than the dielectric constant of the lower layers 112a and/or 112b of dielectric material.

Forming one or more of the lower layers 112a, 112b, and the upper layer 108 of dielectric material using additive manufacturing processes facilitates in fine tuning a height of the corresponding layer of dielectric material, e.g., as described above with respect to FIG. 1B. This in turn allows to fine tune or control one or more parameters of the resultant antenna, in an example, as also described above with respect to FIG. 1B. In one embodiment for the additively manufacturing the one or more layers 112a, 112b, and/or 108 of dielectric material, prior to manufacturing these layers, modeling and simulation tools are employed to determine the appropriate heights of the layers 112a, 112b, and/or 108 for the desired frequency response and properties such as the bandwidth, resonant frequency, gain, and phase. Once the modeling is completed, the one or more layers 112a, 112b, and/or 108 of dielectric material are additively manufactured in accordance with the specification. Because additive manufacturing processes facilitates in fine tuning a height of the corresponding layer of dielectric material, the heights of layers 112a, 112b, and/or 108 may be fine tuned in accordance with the target heights determined during the modeling and simulation.

Optionally (and although not illustrated in FIG. 4), subsequent to process 412 (or any time during the method 400), a shorting structure 305 may be formed within the structure 500, as illustrated in FIG. 5F. For example, opening may be formed (or may be pre-formed) within the layers 112a, 112b, 108 of the dielectric material, and conductive material (such as metal or alloy thereof) may be deposited or inserted within the opening, to form the shorting structure 304.

The method 400 proceeds from 412 to 416. At 416, a conductive patch is formed above upper layer of dielectric material, e.g., as illustrated in FIGS. 5G1 and 5G2. For example, FIG. 5G1 is the structure 500 without the shorting structure 304 (e.g., is formed from the structure of FIG. 5E). On the other hand, FIG. 5G2 is the structure 500 with the shorting structure 304 (e.g., is formed from the structure of FIG. 5F). The conductive patch 104 may be formed using any appropriate deposition technique, such as an additive metal or an alloy deposition process, and may include 3D printing, metal ink printing, or simply attaching a pre-formed patch 104 to the layer 108 using an adhesive.

Note that the processes in method 400 are shown in a particular order for ease of description. However, one or more of the processes may be performed in a different order or may not be performed at all (and thus be optional), in accordance with some embodiments. Numerous variations on method 400 and the techniques described herein will be apparent in light of this disclosure.

FIG. 6 illustrate a flowchart depicting another method 600 of forming an example antenna assembly (such as any of the antenna structures described above), in accordance with an embodiment of the present disclosure. FIGS. 7A, 7B, 7C, and 7D collectively illustrate an example antenna assembly 700 in various stages of processing in accordance with the methodology 600 of FIG. 6, in accordance with an embodiment of the present disclosure. FIGS. 6 and 7A-7D will be discussed in unison.

At 604 of the method 600, a continuous, monolithic, and conductive element 701 is additively manufactured, where the element 701 includes (i) a ground plane 116, (ii) a patch 104 above the ground plane 116, and (iii) one or more structures 702, 304, each structure having a first end in contact with the ground plane and a second end in contact with the patch. Examples of the structures includes the shorting structure 304, and one or more other structures 702 that support the patch 104 above the ground plane 116. Thus, the antenna structure 700 can include the structures 702 and/or the shorting structure 304. Note that at this point, the layers dielectric material has not yet been applied. Accordingly, the patch 104 is supported above the ground plane 116 by the structures 702 and/or 304.

In an example, the element 701 is a monolithic and continuous structure. The element 701 being a monolithic and continuous structure implies that any section of the element 701 is conjoined (e.g., physically joined) with any other section of the element 701 via one or more intervening sections. Thus, the element 701 is a single integral element that has been additively manufactured.

In an example, additively manufacturing the element 701 may include using any appropriate additive manufacturing techniques to form the element 701. For example, additively manufacturing the element 701 may include printing the element 701 using a 3D printer. Additive manufacturing, such as 3D printing, uses computer-aided-design (CAD) software and/or 3D object scanners to direct hardware to deposit material, layer upon layer, in precise geometric shapes. As its name implies, additive manufacturing adds material to create an object. Thus, additive manufacturing involves a computer controlled process that creates 3D objects, such as the element 701, by depositing materials, usually in layers.

The method 600 proceeds from 604 to 608. At 608, one or more lower layers of dielectric material are provided above the ground plane, and one or more feed lines are formed within or on one or more of the lower layer(s) of dielectric material, as illustrated in FIG. 7B. In an example, process 608 is similar to the process 408 of the method 400 described above.

The method 600 proceeds from 608 to 612. At 612, an upper layer 108 of dielectric material above the one or more feed lines is provided, as illustrated in FIG. 7C. In an example, process 612 is similar to the process 412 of the method 400 described above. Subsequent to the formation of the upper layer 108 of dielectric material, now the upper layer 108 of dielectric material can at least in part support the patch 104.

The method 600 proceeds from 612 to 616. At 616, at least a portion of the one or more structures are removed, e.g., as illustrated in FIG. 7D. For example, the one or more structures included the shorting structure 304 and the structure 702. As illustrated in FIG. 7D, the structure 702 is at least in part removed, e.g., such that remnant of the structure 702, if any, is no longer in contact with the ground plane 116 and/or the patch 104. In an example, the structure 702 may be machined or drilled away.

In an example, the process 616 may be optionally omitted. For example, if the structure 701 comprises the shorting structure 304 (and not the structure 702), then the shorting structure 304 need not be removed at process 616.

Note that the processes in method 600 are shown in a particular order for ease of description. However, one or more of the processes may be performed in a different order or may not be performed at all (and thus be optional), in accordance with some embodiments. Numerous variations on method 600 and the techniques described herein will be apparent in light of this disclosure.

### Further Example Examples

The following pertain to further examples, from which numerous permutations and configurations will be apparent.

Example 1. An antenna assembly comprising: a conductive ground plane; a lower layer of dielectric material above the conductive ground plane; an upper layer of dielectric material above the lower layer of dielectric material, wherein at least one of the lower or upper layers of dielectric material comprise dielectric foam; a conductive feed line between at least a section of the lower layer of dielectric material and the upper layer of dielectric material; and a conductive patch above the upper layer of dielectric material, wherein the conductive patch is configured for electromagnetic coupling with the conductive feed line.

Example 2. The antenna assembly of example 1, wherein a dielectric constant of the lower layer of dielectric material is at least 25% more than a dielectric constant of the upper layer of dielectric material.

Example 3. The antenna assembly of any one of examples 1-2, wherein the upper layers of dielectric material comprise dielectric foam.

Example 4. The antenna assembly of any one of examples 1-3, wherein the lower layer of dielectric material is a first lower layer of dielectric material, and wherein the antenna assembly further comprises: a second lower layer of dielectric material above the first lower layer of dielectric material, such that the conductive feed line is between the first and second lower layers of dielectric material, and the upper layer of dielectric material is above the second lower layer of dielectric material.

Example 5. The antenna assembly of example 4, wherein dielectric constants of each of the first and second lower layers of dielectric material are at least 25% more than a dielectric constant of the upper layer of dielectric material.

Example 6. The antenna assembly of any one of examples 1-5, further comprising a shorting structure between the conductive ground plane and the conductive patch, wherein the shorting structure is monolithic and continuous with each of the conductive ground plane and the conductive patch.

Example 7. The antenna assembly of any one of examples 1-6, wherein the conductive feed line is a first conductive feed line, and wherein the antenna assembly further comprises: a second conductive feed line between at least another section of the lower layer of dielectric material and the upper layer of dielectric material.

Example 8. The antenna assembly of any one of examples 1-7, wherein the conductive feed line is within the lower layer of dielectric material.

Example 8a. The antenna assembly of any one of examples 1-8, wherein coupling from the conductive patch to the conductive feed line is free of physical connection.

Example 8b. The antenna assembly of any one of examples 1-8a, wherein coupling from the conductive patch to the conductive feed line is free of solder joints.

Example 8c. The antenna assembly of any one of examples 1-8b, wherein coupling from the conductive patch to the conductive feed line is free of conductive bonds.

Example 9. A method of manufacturing an antenna assembly, the method comprising: additively forming a conductive ground plane; providing a lower layer of dielectric material above the conductive ground plane; forming a conductive feed line on the lower layer of dielectric material; providing an upper layer of dielectric material above the conductive feed line; and forming a conductive patch above upper layer of dielectric material.

Example 10. The method of example 9, wherein providing the upper layer of dielectric material above the conductive feed line comprises: additively forming the upper layer of dielectric material above the conductive feed line.

Example 11. The method of any one of examples 9-10, wherein providing the upper layer of dielectric material above the conductive feed line comprises: providing the upper layer of dielectric material using a foaming process.

Example 12. The method of any one of examples 9-11, wherein the lower layer of dielectric material is a first lower layer of dielectric material, and wherein the method further comprises: forming a second lower layer of dielectric material above the conductive feed line, such that the conductive feed line is sandwiched between the first and second lower layers of dielectric material.

Example 13. The method of example 12, wherein dielectric constants of each of the first and second lower layers of dielectric material are at least 25% more than a dielectric constant of the upper layer of dielectric material.

Example 14. The method of any one of examples 9-13, wherein providing the lower layer of dielectric material above the conductive ground plane comprises: additively forming the lower layer of dielectric material above the conductive ground plane.

Example 15. The method of any one of examples 9-14, wherein the conductive feed line is a first conductive feed line, and wherein the method further comprises: forming a second conductive feed line on the lower layer of dielectric material.

Example 16. A method of manufacturing an antenna assembly, the method comprising: additively manufacturing an element that includes (i) a ground plane, (ii) a patch above the ground plane, and (iii) a structure having a first end in contact with the ground plane and a second end in contact with the patch, such that the structure is monolithic and continuous within the ground plane and the patch; providing a lower layer of dielectric material between the ground plane and the patch; forming a feed line on or within the lower layer of dielectric material; and providing an upper layer of dielectric material between the feed line and the patch.

Example 17. The method of example 16, further comprising: removing at least a portion of the structure, such that a remnant of the structure, if any, is no longer in contact with the ground plane and/or the patch.

Example 18. The method of any one of examples 16-17, wherein the structure forms a direct current (DC) shorting structure between the ground plane and the patch.

Example 19. The method of any one of examples 16-18, wherein providing the upper layer of dielectric material comprises: providing the upper layer of dielectric material using a foaming process.

Example 20. The method of any one of examples 16-19, wherein additively manufacturing the element comprises printing the element using a three-dimensional (3D) printing process.

Numerous specific details have been set forth herein to provide a thorough understanding of the examples. It will be understood, however, that other examples may be practiced without these specific details, or otherwise with a different set of details. It will be further appreciated that the specific structural and functional details disclosed herein are representative of examples and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims. Furthermore, examples described herein may include other elements and components not specifically described, such as electrical connections, signal transmitters and receivers, processors, or other suitable components for operation of the antenna system 100.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and examples have been described herein. The features, aspects, and examples are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. An antenna assembly comprising:
a conductive ground plane;
a lower layer of dielectric material above the conductive ground plane;
an upper layer of dielectric material above the lower layer of dielectric material, wherein at least one of the lower or upper layers of dielectric material comprise dielectric foam;
a conductive feed line between at least a section of the lower layer of dielectric material and the upper layer of dielectric material; and
a conductive patch above the upper layer of dielectric material, wherein the conductive patch is configured for electromagnetic coupling with the conductive feed line.

2. The antenna assembly of claim 1, wherein a dielectric constant of the lower layer of dielectric material is at least 25% more than a dielectric constant of the upper layer of dielectric material.

3. The antenna assembly of claim 1, wherein the upper layer of dielectric material comprise dielectric foam.

4. The antenna assembly of claim 1, wherein the lower layer of dielectric material is a first lower layer of dielectric material, and wherein the antenna assembly further comprises:
a second lower layer of dielectric material above the first lower layer of dielectric material, such that the conductive feed line is between the first and second lower layers of dielectric material, and the upper layer of dielectric material is above the second lower layer of dielectric material.

5. The antenna assembly of claim 4, wherein dielectric constants of each of the first and second lower layers of dielectric material are at least 25% more than a dielectric constant of the upper layer of dielectric material.

6. The antenna assembly of claim 1, further comprising a shorting structure between the conductive ground plane and the conductive patch, wherein the shorting structure is monolithic and continuous with each of the conductive ground plane and the conductive patch.

7. The antenna assembly of claim 1, wherein the conductive feed line is a first conductive feed line, and wherein the antenna assembly further comprises:
a second conductive feed line between at least another section of the lower layer of dielectric material and the upper layer of dielectric material.

8. The antenna assembly of claim 1, wherein the conductive feed line is within the lower layer of dielectric material.

9. A method of manufacturing an antenna assembly, the method comprising:
additively forming a conductive ground plane;
providing a lower layer of dielectric material above the conductive ground plane;
forming a conductive feed line on the lower layer of dielectric material;
providing an upper layer of dielectric material above the conductive feed line; and
forming a conductive patch above upper layer of dielectric material.

10. The method of claim 9, wherein providing the upper layer of dielectric material above the conductive feed line comprises:
additively forming the upper layer of dielectric material above the conductive feed line.

11. The method of claim 9, wherein providing the upper layer of dielectric material above the conductive feed line comprises:
providing the upper layer of dielectric material using a foaming process.

12. The method of claim 9, wherein the lower layer of dielectric material is a first lower layer of dielectric material, and wherein the method further comprises:
forming a second lower layer of dielectric material above the conductive feed line, such that the conductive feed line is sandwiched between the first and second lower layers of dielectric material.

13. The method of claim 12, wherein dielectric constants of each of the first and second lower layers of dielectric material are at least 25% more than a dielectric constant of the upper layer of dielectric material.

14. The method of claim 9, wherein providing the lower layer of dielectric material above the conductive ground plane comprises:
additively forming the lower layer of dielectric material above the conductive ground plane.

15. The method of claim 9, wherein the conductive feed line is a first conductive feed line, and wherein the method further comprises:
forming a second conductive feed line on the lower layer of dielectric material.

16. A method of manufacturing an antenna assembly, the method comprising:
additively manufacturing an element that includes (i) a ground plane, (ii) a patch above the ground plane, and (iii) a structure having a first end in contact with the ground plane and a second end in contact with the patch, such that the structure is monolithic and continuous within the ground plane and the patch;
providing a lower layer of dielectric material between the ground plane and the patch;
forming a feed line on or within the lower layer of dielectric material; and
providing an upper layer of dielectric material between the feed line and the patch.

17. The method of claim 16, further comprising:
removing at least a portion of the structure, such that a remnant of the structure, if any, is no longer in contact with the ground plane and/or the patch.

18. The method of claim 16, wherein the structure forms a direct current (DC) shorting structure between the ground plane and the patch.

19. The method of claim 16, wherein providing the upper layer of dielectric material comprises:
providing the upper layer of dielectric material using a foaming process.

20. The method of claim 16, wherein additively manufacturing the element comprises printing the element using a three-dimensional (3D) printing process.
